(19) United States
(12) Patent Application Publication
(10) Pub. No.: US 2016/0148165 A1
(43) Pub. Date: May 26, 2016

(54) SYSTEM AND METHODS FOR FACILITATING IN-PERSON RECIPROCAL PROFESSIONAL NETWORKING MEETINGS

(71) Applicant: Joe Hanns Prempeh, Chicago, IL (US)

(72) Inventor: Joe Hanns Prempeh, Chicago, IL (US)

(21) Appl. No.: 14/605,826

(22) Filed: Jan. 26, 2015

Related U.S. Application Data
(60) Provisional application No. 62/084,485, filed on Nov. 25, 2014.

(51) Int. Cl. G06Q 10/10; G06Q 20/22

(52) U.S. Cl. CPC G06Q 10/1095; G06Q 20/22

(57) ABSTRACT

A system and methods for creating a mutually beneficial in-person professional networking opportunity through an in-person scheduled meeting with a user offering to perform a service within her professional capacity in exchange for a one-time fixed price to be paid by users seeking such service.

When the network service offeror posts the meeting, the offeror indicates the specific network service, the timeline within which the service will be performed, and the conditions under which the service will be performed. A limit is placed on the maximum number of seekers that can book any meeting. The seeker decides the minimum number of bookings that must be placed before she is approved, charged a proportionate share of the cost and confirmed. At the end of the booking time, approved seekers are charged and confirmed. The network offeror and seekers receive final confirmation notice with details about the meeting.

### CROSS-REFERENCE TO RELATED APPLICATIONS

This application claims the benefit of U.S. Provisional Application No. 62/084,485 filed Nov. 25, 2014.

In one embodiment, a method includes receiving a plurality of in-person professional network meeting offers with associated promise to perform specified services, accessing a plurality of in-person professional network service meeting offerings, accessing the in-person professional network service offering requirements, accessing the professional profile information of both the network service offeror and seeker, and allowing network seeker to book appointment to attend the in-person meeting and receive the service offering after making a payment as a reciprocal benefit to the offeror.

### FIELD OF THE INVENTION

This invention relates generally to the offer and acceptance of a plurality of in-person professional network meeting with associated service offer. More specifically, the invention relates to a system and methods for facilitating in-person professional network meetings by allowing users to post, by way of offers, in-person meetings and indicate professional network services to be performed from a predetermined list, indicate an amount to be charged for the in-person meeting and associated service, and specify a time within which the network offering must be accepted through a network system such as the internet. The acceptance of an offer for in-person professional networking meeting and service offering is contingent upon the payment of a fee set by the network offeror with payment obligation split equally amount a plurality of network seekers who book appointment, are accepted by the network offeror, and confirmed to attend within the specified period of time.

### BACKGROUND

Professional networking is the exchange of information or services among individuals, groups, or institutions for the cultivation of productive relationships for employment or business opportunities. Increasingly these networking activities are done online through social and professional networking websites. Typically on these websites, parties seeking networking opportunities rely on emails and other message formats to develop professional relationships. These networking sites are not built to facilitate in-person networking opportunities. People and businesses simply do not get the opportunity to translate their online networking contacts into actual in-person networking opportunities.

Another feature associated with online networking is that it has traditionally been one-sided wherein the person seeking an opportunity selects the organization or individual she wants to network with, sends out a message or call that person or organization and requests direct favor or opportunity. The network seeker usually adds the person or organization to her contact list and sends occasional messages in hopes of building a professional relationship. This approach creates a one-sided benefit, which discourages the side from whom an opportunity is sought. This situation renders several professional contacts developed online ineffective because of the lack of reciprocal benefits.

In-person meeting is an integral part of networking. A higher value is placed on in-person professional networking than strictly online professional networking in situations where the parties do not have prior relationship. In-person professional network meeting is preferred because parties can assess each other better, build trust and identify mutually beneficial interests. People network with others online with the hope that they will gain what in-person networking will provide.

A trend has emerged in the online networking platforms. Some of the trends include building an attractive user profile and resume page on websites such as Linkedin, and inviting people into your network or accepting invitations from people who want to be in your network. But these techniques have several weaknesses. Most of the online network techniques create the notion that a person's profile will be viewed by other people interested in it, or get referrals from people within the networking group. But, in actuality, people have been hesitant to give referrals to those they do not know in person. A small percentage of people who invite or accept invitation from other people into their networks actually ends up getting to know the people they invited or accepted into their networks.

There is also a sense of invasion when a random person requests to be part of another person's network without any prior relationship. Usually, reputable organizations and prominent people receive numerous invitations from random people who want to network for employment opportunities or business development. Since the benefit of such networking invitation is almost always one-sided, prominent individuals and reputable organizations do not find value in networking with people or other organizations that do not offer something of value in exchange.

Furthermore, in an online networking platform, the only thing at stake is an online user-profile. As a result, people exaggerate their background qualifications and titles and thus, make purely online networking less trustworthy. Constant invitations from random people who seek network opportunities without a reciprocal value has become a problem with online professional networking whereas the failure to add people into one's online networking group creates the concern that the person may not be exposing herself as much as she should to gain a networking opportunity.

Recruitment agencies and employers seeking workers usually spend several hours searching through user-profiles without any information on whether the people are still searching for employment, or whether the profiles are accurate and updated. The current networking techniques have succeeded in raising hopes of networking opportunities online but in actuality, the technique has generated lower percentage of actual opportunities to both the people seeking professional networking opportunities and the ones from whom opportunities are being sought.

A few companies, such as Eventbrite and Meet.Com, allow users to list a plurality of in-person networking events on a web platform. Eventbrite allows people and organizations to host meetings at specified locations with free admission or paid admission. Eventbrite concept however does not resolve the problems inherent in online professional network. There is currently no online system or methods that offer a reciprocal benefit for in-person networking opportunity, wherein the person offering the in-person professional networking meeting is required to state a network service to perform at a specified price for other people seeking such professional networking service. There is no system or method that allows for a reciprocal network opportunity by allowing one party to offer the opportunity from a predetermined list and the other party required to pay for the opportunity. There is also no system or method that assigns in equal proportion the cost of an in-person professional networking meeting with associated service offering among the people who book appointments and are accepted by the network offeror. There is also no system or method that removes the uncertainties of networking online as to whether a person is interested in providing a particular professional network service for other network seekers by first meeting them in person. The present invention satisfies these needs.

### SUMMARY OF THE INVENTION

According to the present invention, there are two types of users: an offeror and a seeker. An offeror is a user who offers in-person professional networking meeting with associated service offering on his behalf or on behalf of his company. A seeker is a user who seeks in-person professional networking meeting with specific service opportunity for himself or the benefit of his company.

The present invention is a system and methods that facilitates the creation of a plurality of in-person professional network meeting and service offerings through mutually beneficial in-person scheduled meeting between a user offering networking service and another user seeking networking service opportunity. The offeror posts an in-person professional network meeting and selects from a list of predetermined networking service or specifies her own opportunity to be offered, indicates the maximum number of people allowed to attend, indicates the amount of money to be charged for the network service offering, and specifies the place and duration of the meeting.

This invention provides that every user whether offering or seeking networking service opportunity will be grouped under one of three different levels of employment classification, which is determined by an algorithm that uses factors such as position in a company, years of experience, and nature of company. Once a user's level has been established, the user can either seek networking opportunity or offer networking opportunity at the same level or above or below the user's level.

The offeror of the in-person professional network meeting indicates the type of service opportunity to be offered, the amount of money that must be paid in exchange for the specified opportunity, the duration of the meeting, the place of the meeting, the timeframe within which users must respond to the offer, and the number of people allowed to attend. Only users who book an appointment, are accepted by the offeror and make the required payment before the allowable time expires are confirmed to attend the in-person meeting and receive the benefit of the associated service offering: and where there is a plurality of users who book, are accepted and confirmed, the cost is split in an equal proportion among the total number confirmed.

The present invention eliminates the uncertainties of networking online by permitting a user to indicate exactly the nature of networking opportunity the user wants to offer. The user seeking an opportunity can review profiles and ascertain the value that an offeror can provide. The in-person network offeror has the option to accept or reject bookings if after reviewing the profiles of the network seekers she determines that she cannot fulfil the obligation to a particular seeker. Unwarranted professional networking requests and uncertainties in reaching out to other professionals are eliminated because users make themselves available to be reached by posting their networking value proposition on the communication platform such as a website or mobile application.

The present invention allows a user to specify the amount of money that must be paid and the maximum number of people that are permitted to book. In this present invention, the amount of money that offerors charge are split evenly among seekers who are confirmed to attend the in-person meeting. In this way, each user booking a networking appointment knows both the possible minimum and maximum amount of his proportionate share of the cost. It is only after the offeror has approved and confirmed the final number of seekers who are allowed to attend the in-person meeting that each seeker will know the exact amount of his or her proportionate share of the cost. The present invention allows a network seeker to set a maximum proportionate share of the cost beyond which the seeker must be removed from the booking list.

The in-person meeting offer will remain open on the network platform such as the internet or a mobile application for a limited time until the maximum number of seekers have booked and are accepted, or the allotted time has elapsed, whichever comes first. For example, a user may offer an in-person meeting with associated service offering open to 5 people for a one hour time period at a price of $200, which must be booked within 7 days. The meeting will be confirmed if 5 people book an appointment by the 7th day and are accepted by the offeror. If 5 people book but only 4 are accepted, the offer will remain open until the 7^{th} day at which time the 4 accepted bookings are confirmed. Each user who booked and was accepted and confirmed will then be charged a proportionate share of the $200. In the first scenario, because 5 people were confirmed, each seeker will be charged $40. In the second scenario because 4 people were confirmed, each person will be charged $50. Seekers also have the option to indicate the maximum amount of money they are willing to pay. If a seeker restricted the maximum proportionate amount to $40, then under scenario 1, that seeker will be confirmed. Under scenario 2, although the seeker was approved, the seeker will be removed and not confirmed. The remaining 3 confirmed seekers will each be charged a proportionate share of $66.66.

The in-person networking service offer is accessed either through a global communication network such as the internet, intranet, email or another communication network. Where an internet is used, a website is generated and updated with the offer posting such that in-person network opportunity seekers can review offers and pay for bookings. Users must first register in order to view offer details on the network platform. Registration may entail providing one or more of the following types of information: the name of the user, physical address, email address, professional experience, position, employer, and a form of payment, such as a credit card or debit card.

All users who successfully book a meeting are notified of concealed details of the meeting such as the specific location and documents to bring along. Each user who books and is confirmed is charged a proportionate share of the cost using the user's provided method of payment. i.e., credit card, debit card, Paypal, Dwolla or in other ways utilizing an online payment method. The offeror is provided with a detailed resume of all the seekers she will be meeting in-person and a unique verification number of each person. The seekers are also provided a detailed confirmation of the meeting place, the terms of the service offering, the time, and duration through an email communication.

The offer may be cancelled in one of three ways. The offer may be cancelled prior to the expiration of the allowable time within which users may book an appointment. The offer may also be cancelled if the minimum number of users required to book an appointment is not reached. Finally seekers may also cancel their booking any time before 24 hours prior to meeting date and before the booking is confirmed. Users may opt into a notification list wherein new in-person networking service offers in various professional categories such as Accounting, Investment banking, Legal or Sales industries are communicated to them. The invention also provides a means by which users can search for networking offers from different regions such as countries, states, cities or through the use of zip codes.

An object of the present invention is to provide one group of users with a valuable service by discussing the details in an in-person professional networking meeting while providing the other group of users with monetary payment for the networking service being offered.

Another object of the present invention is for a user to gain direct benefit and exposure to others by creating a mutuality of interest through the in-person networking meetings.

Another object of the present invention is to promote the integrity of online professional profiles by creating an incentive for users to be truthful about their background and qualifications.

Another object of the present invention is to enhance job opportunities and professional development by building upon relationship developed from the in-person meeting.

Another object of the present invention is to provide a system and methods for converting online networking relationship into actual in-person relationship for effective business and career development.

Another object of the present invention is to eliminate the unwarranted professional network friendship request and create a reciprocal interest in network meetings.

These aspects and benefits of the present invention as well as other features will become more apparent from the attached drawings and the detailed description of the preferred embodiments.

### BRIEF DESCRIPTION OF THE DRAWINGS

The preferred embodiments of the invention will be described in conjunction with the attached drawings provided as an illustration and not a limitation to the invention:

FIG. 1 illustrates a flow chart in accordance with one embodiment of the present invention; and

FIG. 2 illustrates a flow chart in accordance with an alternative embodiment of the present invention; and

FIG. 3 illustrates an example of a computer system according to the present invention.

### DETAILED DESCRIPTION OF THE PREFERRED EMBODIMENT

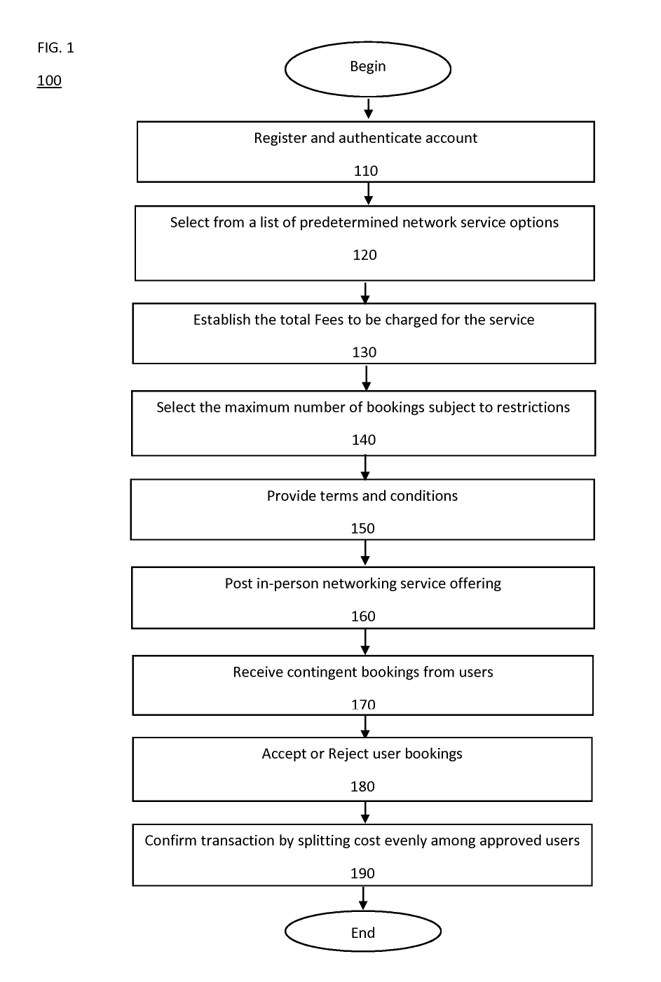

FIG. 1 illustrates an example flow chart 100 in accordance with one embodiment of the present invention. In FIG. 1, a user registers an account on a network such as a website or a mobile application and authenticates the account at step 110 for membership in the present invention. The registered user is an individual acting on her own or on behalf of a business entity. The user provides a detail professional profile and specifies a work experience, title, position and geographic location.

A predetermined list of network options are provided at step 120. The user selects a single service option or a plurality of service options to offer to users seeking such opportunities.

The user determines the total amount of money to charge as fees for the services to be offered at step 130. The amount charged may be influenced by the duration of the in-person network meeting and the quantity of service options being offered. This fee is non-negotiable.

The user sets the maximum number of people that can attend the in-person professional network meeting and receive the associated service offering at step 140. To promote efficient networking and increase the probability of effective execution of the offered service, the system puts a limit on the maximum number that any in-person networking meeting can have.

At step 150, terms and conditions of the in-person professional network service offer are provided by the user, which may include but not limited to a minimum qualification an in-person network seeker must have, the timeframe within which the service offering will be fulfilled, the exact location, time and duration of the in-person meeting and disclaimers.

The in-person professional network meeting and service offering is posted on the network at step 160. The offer may be posted through a website or a mobile application over an internet system. The posted offer will be displayed with the offeror's profile, booking fees, maximum number of permitted bookings, number actually booked and timeframe within which booking must take place.

Seekers of professional in-person network meetings research postings on the network, review offerors' profiles and network service offerings and associated terms and conditions at step 170. A seeker then places contingencies on her booking. A contingency is based upon a minimum number of seekers that must book an appointment before the seeker's booking can be confirmed. Seekers who book are initially placed on a waiting lists until their stated minimum number of seekers book an appointment at which time their profile and bookings are presented to the offeror for either acceptance or rejection at step 180.

At step 180, all the bookings that have their contingencies satisfied are presented to the offeror for review. The offeror then accepts or rejects a booking and a notification is sent to the seekers at least 24 hours before the date of the meeting. The contingency mechanism allows each seeker to determine the maximum proportionate amount of money she will be charged based on the maximum number set at step 140 if her booking is accepted.

At step 190 the seekers whose bookings were accepted at step 180 are charged a proportionate share of the fees. The fees are divided equally among the seekers and payment is taken from each seeker's preferred method of payment such as a credit card. Payment confirmation and meeting details are sent to both the offeror and the seekers that have been confirmed.

By way of example but not a limitation, a user who is a junior associate in a law firm registers on the site and authenticates her account. The associate uploads her resume and completes a short questionnaire and the system's algorithm determines a level between one and three to place the junior associate. The associate then goes through the predetermined list of network service options and selects one or more from the list. For example the associate may select “I will hand-deliver your resume to our hiring manager” and/or “I will invite you to our law firm social events to network your way up.”

The associate then decides that she will charge $100 for such a network service offerings. She selects the maximum number of people that can attend the in-person meeting to receive the service offering. The system indicates a maximum number beyond which the associate cannot exceed. By way of example, the system sets the maximum number at 6 and the associate decides that the maximum number of people that can book the in-person meeting with her is 5.

The associate describes the terms and conditions associated with her service. For instance, in order for the associate to hand-deliver a resume to the hiring manager, the seeker must be enrollment in an ABA law school with a GPA of 3.0 or better.

The associate posts the service offering on the website or mobile application for users seeking such opportunities to review and book a meeting. A seeker must first put a contingency on the minimum number of other seekers that must book before her booking is accepted and subsequently confirmed. For instance, a seeker may select a number between 0 and the maximum number of users permitted to book. If the seeker selects 2 as a contingent minimum number, then there must be at least 2 bookings before that seeker's booking if accepted can be confirmed. In this way the seeker is certain that her maximum fee obligation will not exceed $33.33 if only 3 people with herself included end up being the only ones who booked, were accepted and confirmed. The seeker will also know that her minimum fee obligation will be $20.00 if all the 5 maximum number of bookings are accepted and confirmed.

The associate then reviews the profile of the seekers who have booked an appointment and the associate has the option to accept or reject any seeker who does not meet the terms and conditions.

After the associate makes the final confirmation of the bookings, the system splits the cost evenly among the confirmed seekers. In this scenario, 5 people booked an appointment and the associate accepted 4 of them. Thus, each seeker will be charged $25.00.

A final confirmation is sent to both the associate and the seekers with details about the place and duration of the meeting. The associate receives a verification code for each of the 4 seekers confirmed to attend the in-person meeting and discuss the associated service offering.

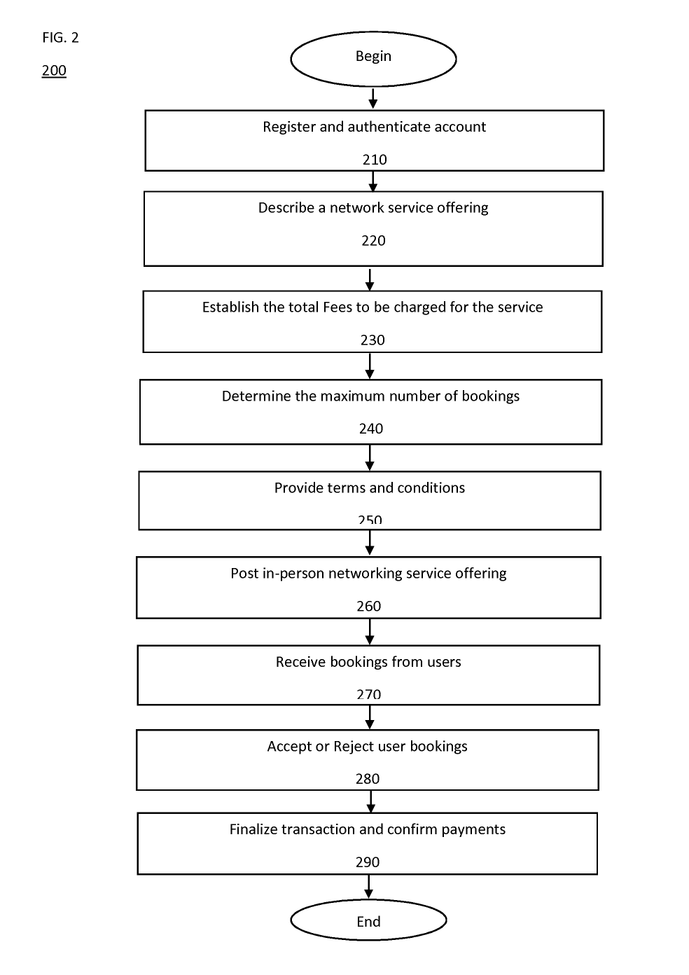

FIG. 2 is an alternative embodiment of the present invention illustrated in flow chat 200. A user registers and authenticates an account at step 210. In this alternative embodiment, there is no predetermined list of in-person network service offering to select. The user creates her own network service offering at step 220 by briefly describing in a title format the service she will provide. The offeror may describe and create a plurality of services to offer to network seekers.

Similar to FIG. 1, the offeror establishes a fee to charge for the network service offering at step 230. At step 240 the offeror determines the maximum number of people that can place a booking. The system does not put any limitation on the number of people who can book and attend the in-person networking meeting.

At step 250 the offeror provides terms and conditions for the meeting and the associated network service offering. This allows network seekers to evaluate the offering and determine if they meet the requirements. The in-person network service offering is then posted at step 260 on the network for users seeking professional network service opportunities to search, review and book appointments.

In this alternative embodiment, network service offerors receive bookings from network service seekers without any contingencies at step 270. The system automatically calculates each person's proportionate share of the cost based on the numbers provided at steps 230 and 240. The network seeker pays only the ascertained proportionate fraction of the fees.

Similar to FIG. 1, the network offeror reviews all bookings and associated profiles of the network seekers and either accepts or rejects the bookings at step 280. All the accepted bookings are finalized at step 290.

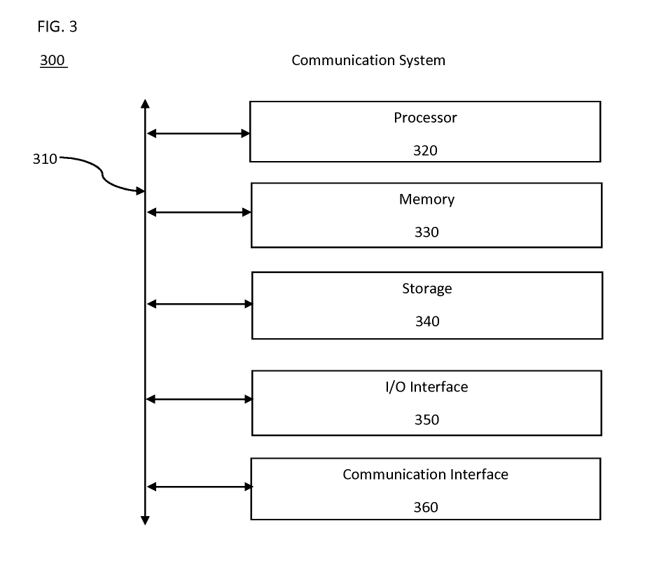

FIG. 3 illustrates an exemplary computer system 300. FIG. 3 contemplates any suitable computer system 300. In particular embodiments, one or more computer systems 300 execute the methods presented herein. In particular embodiment, one or more computer systems 300 performs the functionality described herein. This disclosure contemplates any suitable computer system with suitable components and not limited to the system and components described and illustrated herein.

In particular embodiments, computer system 300 includes a bus 310, processor 320, memory 320, storage 340, an input/output (I/O) interface 350, and a communication interface 360. Bus 310, in the form of a software, hardware or a combination or both, connects the processor 320 to various other components of the computer system 300. The disclosure contemplates bus 310 being connected to processor 320 to various components of the computer system. The disclosure further contemplates that bus 310 may include one or more bus 310 in some situations.

In particular embodiment, processor 320 includes a hardware for executing commands in a form of computer code through the bus 310. As an example and not a limitation, “computer code” includes, instructions, data and programs. Computer system 300 may include one or more memories, such as memory 330 for storing code for processor 320. By way of example and not a limitation, the memory 330 may be magnetic storage device, random access memory (RAM) or other forms of mass storage device. In particular embodiments, the processor executes instructions in memory 330.

In particular embodiments, storage 340 constitutes a mass storage device having a mass storage drive and media for storing computer code including instructions, data and programs. By way of example and not a limitation, the storage device 340 may include Universal Serial Bus (“USB”), floppy storage device, Hard Disk Device (“HDD”), Compact Disc Read-Only Memory (“CDROM”), magnetic storage device, optical storage device, or Micro-Electro-Mechanical Systems (“MEMS”). It is contemplated that the storage drive within the storage device 340 may be removable. It is also contemplated that mass storage 340 will take any suitable form.

In particular embodiments, the computer system 300 may include an input/output (“I/O”) interface 350 which may be in a form of a software, hardware or in some instances a combination of both for providing one or more interfaces for computer code to be communicated between the computer system 300 and one or more I/O. One or more of the I/O such as a keyboard, Bluetooth, mouse or video graphics adapter (“VGA”) may allow a person to communicate with the computer system 300 through computer code in a form of signals such as electromagnetic, electronic or optical signals, by way of example and not a limitation.

In particular embodiments, communications interface 360 may be in a form of a software, hardware or in some instances a combination of both for providing one or more interfaces for computer code to be communicated between the computer system 300 and one or more networks or other external computer systems. Computer signals in the form of electromagnetic, electronic, optical and other signals, by way of examples and not a limitation, are the typical forms by which the Computer code are transferred between the Communications interface 360 and the other networks. For instance, the Communications interface may include a network interface controller (“NIC”) for communicating with a wire, wireless, fiber optics or radio frequency network system. This invention disclosure contemplates any suitable communication interface.

It is also contemplated that the methods according to the present invention may be performed automatically, manually or a combination of the two. The invention disclosure also includes any suitable combination of one or more features from any of the embodiments used as an example with one or more features of any other example embodiment that a person ordinarily skilled in the art would understand.

1. A method of in-person professional network meeting with associated service offering in which a fee is charged by the network offeror in exchange for the service being offered wherein network service seekers preauthorizes payment but do not know their proportionate share of the fee until the timeframe for booking for the meeting has expired at which point individual fee obligations are established by splitting the total fee equally among the seekers who are accepted by the offeror and confirmed;
comprising a network server, a microprocessor, a memory and computer software, said computer software being located in said memory and operated by said microprocessor, said computer software comprising an in-person professional network service offering facilitating algorithm, wherein said in-person professional network service offering facilitating algorithm comprises the steps of:
i. receiving a selection from a list of pre-programmed network service options by a user who wants to provide said selected service to other users for a fee;
ii. receiving a fee information to be charged for said meeting and service, said fee being the total amount for the meeting and service being offered;
iii. establishing the maximum number of users that can book an appointment to attend the in-person meeting and receive the network service offering;
iv. generating a post to display said in-person professional network meeting and service offering to users;
v. displaying said post over a network through said network server for a predetermined time period;
vi. receiving contingent bookings from users seeking said in-person professional network service opportunity;
vii. evaluating contingencies to ensure that said contingencies are satisfied before presenting bookings to offeror;
viii. presenting bookings with satisfied contingencies to offeror for acceptance or rejection;
ix. apportioning fees equally among all the seekers accepted for the meeting by dividing the fees among the number of seekers accepted; and
x. sending confirmation notes to seekers who accepted and charged for the meeting.

2. The method of in-person professional network meeting and service offering of claim 1, wherein the posted meeting information displays one or more details about the meeting and service offering including:
the professional category under which the offeror is affiliated;
the terms and conditions associated with the meeting and the service to be offered;
the date and time of the in-person meeting;
the number of people who have booked an appointment to attend the meeting;
the number of people who have been approved to attend the in-person meeting and receive the associated service offering; and
the geographic location of the in-person meeting.

3. The method of in-person professional networking meeting and service offering of claim 1, wherein said meeting is an offer of a service to be performed by the person offering the in-person professional network meeting.

4. The method of claim 1, wherein the offer of a specific network service opportunity through an initial in-person meeting eliminates awkwardness in seeking professional network assistance.

5. The method of claim 1, wherein each registered user is categorized into one of three levels of professional classifications.

6. The method of in-person professional network meeting and service offering of claim 1, wherein said posted offering includes a detailed professional profile resume of each user.

7. The method of in-person professional network service offering of claim 1, wherein a network service seeker puts a limit on the maximum amount of proportionate fee obligation that the seeker can be charged.

8. The method of in-person professional network meeting and service offering of claim 1, wherein said preprogrammed list of network service offering is greater than one.

9. The method of in-person professional network meeting and service offering of claim 1, wherein a network service offeror selects a plurality of network services from the preprogrammed list.

10. The method of in-person professional network service offering of claim 1, wherein a network service offeror creates a plurality of network service offering.

11. The method of in-person professional network meeting and service offering of claim 1, wherein said displaying said network posting over a network through said network server comprises presenting the network posting to said interested network seekers through the display on the network seeker's computer.

12. The method of in-person professional network meeting and service offering of claim 1, wherein said displaying said network posting over a network through said network server comprises presenting the network posting to said interested network seekers through the display on the network seeker's mobile device.

13. The method of in-person professional network meeting and service offering of claim 12, wherein said mobile device comprises a smart watch, a laptop, tablet, phablet, personal digital assistant or cellular telephone.

14. The method of in-person professional network meeting and service offering of claim 1, wherein said receiving a booking request from a network seeker for the meeting comprises receiving request for acceptance to the meeting and performance of the associated service.

15. The method of in-person professional network meeting and service offering of claim 14, wherein said receiving a booking request from a network seeker requesting acceptance from the offeror comprises obtaining prepayment authorization and detail profile resume from said network seeker.

16. The method of in-person professional network meeting and service offering of claim 15, wherein said network service offeror reviews the detail profile resume of said network seeker, said review comprising evaluation of qualification.

17. The method of in-person professional network meeting and service offering of claim 1, wherein said determining of individual seeker's proportionate share of the fee charged comprises simple algebra of dividing the posted fee by the final number of seekers booked and approved.

18. The method of in-person professional network meeting and service offering of claim 1, wherein said confirmation of the approved booking comprises providing each network seeker with a meeting confirmation notice with details of the meeting and payment invoice.
